(19) United States
(12) Patent Application Publication
(10) Pub. No.: US 2004/0264202 A1
(43) Pub. Date: Dec. 30, 2004

(54) Lamp arm structure

(75) Inventor: Ying-Ming Lu, Taipei (TW)

Correspondence Address: BACON & THOMAS, PLLC, 625 SLATERS LANE, FOURTH FLOOR, ALEXANDRIA, VA, 22314

(73) Assignee: LON TAI SHING CO., LTD., TAIPEI (TW)

(21) Appl. No.: 10/603,617

(22) Filed: Jun. 26, 2003

(51) Int. Cl. B60Q 3/04

(52) U.S. Cl. 362/362

(57) ABSTRACT

A lamp arm structure which is an elongated chain structure composed of multiple coupling blocks which are serially connected. Each coupling block has an annular flange at the middle to divide the coupling block into two ends. One end of the coupling block is formed with a cup-like socket section, while the other end is formed with an engaging section having several domed protuberances on the surface. The engaging section of one coupling block can be inserted into the socket section of another coupling block to serially connect the coupling blocks into the chain structure. Each coupling block can be freely universally rotated about the engaging section so that the lamp arm can be multidirectionally bent to adjust the angle of a bulb holder.

### BACKGROUND OF THE INVENTION

The present invention is related to a movable lamp arm, and more particularly to a lamp arm structure which can be freely multidirectionally bent to adjust the angle of a bulb holder.

A conventional lamp arm is connected between a lampshade and a lamp seat. The lamp arm includes a support arm and a swiveling arm. One end of the support arm is equipped with a double-face joint having circular plane face. One end of the swiveling arm is formed with circular plane face cooperating with the circular face of the double-face joint. Steel belt and spring are disposed on the circular plane faces and coupled by screws. The using life of such lamp arm is limited to the using life of the steel belt and spring so that such lamp arm can be hardly durably used. Most problematically, the movable joint composed of two arms having corresponding semicircular ends can be only angularly moved within the same circumference. Once the lamp arm is moved by an angle exceeding the angle range, the lamp arm will be damaged or broken.

### SUMMARY OF THE INVENTION

It is therefore a primary object of the present invention to provide a lamp arm structure which can be freely universally turned. The lamp arm structure is an elongated chain structure composed of multiple coupling blocks which are serially connected. One end of each coupling block is formed with a cup-like socket section, while the other end is formed with an engaging section having several domed protuberances on the surface. The engaging section of one coupling block can be inserted into the socket section of another coupling block to serially connect the coupling blocks into the chain structure. Each coupling block can be freely universally rotated about the engaging section so that the lamp arm can be multidirectionally bent to adjust the angle of the lamp.

The present invention can be best understood through the following description and accompanying drawings wherein:

### BRIEF DESCRIPTION OF THE DRAWINGS

FIG. 1 is a perspective view of a preferred embodiment of the present invention;

FIG. 2 is a perspective view of the coupling block of the preferred embodiment of the present invention; and

FIG. 3 is a perspective view of the preferred embodiment of the present invention, showing the operation of the lamp arm structure.

### DETAILED DESCRIPTION OF THE PREFERRED EMBODIMENT

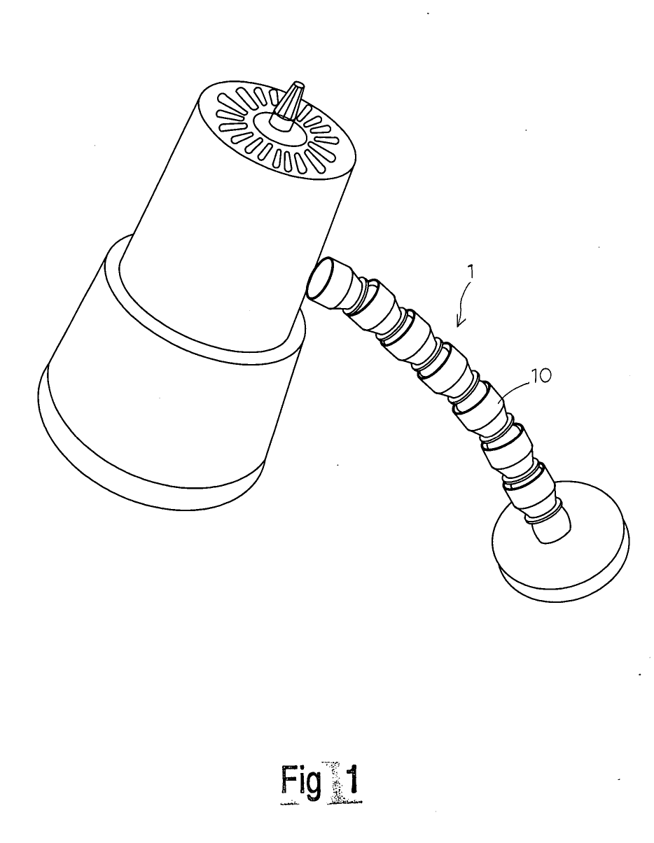

Please refer to FIGS. 1 to 3. The lamp arm structure of the present invention is connected between a lampshade and a lamp seat.

The lamp arm is an elongated chain structure 1 composed of multiple coupling blocks 10 which are serially connected.

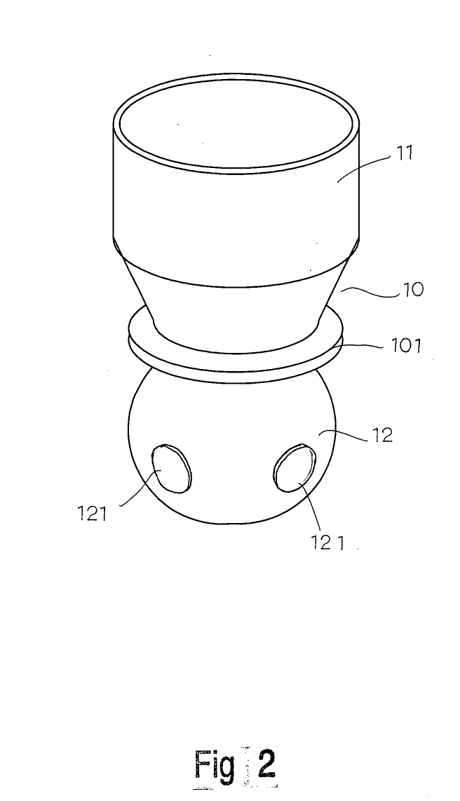

FIG. 2 shows one coupling block 10 which has an annular flange 101 at the middle to divide the coupling block 10 into two ends. One end of the coupling block 10 is formed with a cup-like socket section 11, while the other end is formed with an engaging section 12 having several domed protuberances 121 on the surface. The engaging section 12 can be inserted into the socket section 11 and the domed protuberances 121 of the engaging section 12 prevent the engaging section 12 from freely detaching from the socket section 11.

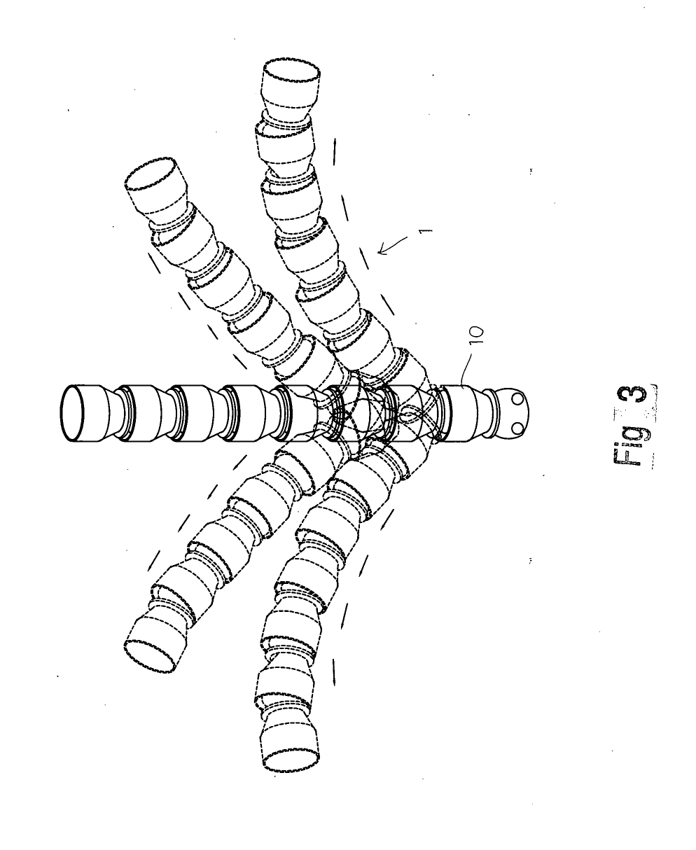

When assembled, the engaging section 12 is inserted into the socket section 11 to serially connect the coupling blocks 10 into an elongated chain structure as shown in FIG. 3. This structure is connected between the bulb holder and the lamp seat as a lamp arm. Each coupling block can be freely universally rotated about the engaging section 12 so that the lamp arm can be multidirectionally bent to adjust the angle of the bulb holder.

After the chain structure is bent to a certain extent and located, the chain structure will not resiliently restore. Therefore, without the assistance of any steel belt or spring, the lamp arm structure can be freely bent and located. Accordingly, the using life of the movable joint of the lamp arm is not limited to the using life of the steel belt or spring. Moreover, without the spring, the lamp arm can be mobilely turned. On the other hand, without the steel belt and spring, the cost is lowered and the assembly is facilitated.

The above embodiment is only used to illustrate the present invention, not intended to limit the scope thereof. Many modifications of the above embodiment can be made without departing from the spirit of the present invention.

What is claimed is:

1. A lamp arm structure which is an elongated chain structure composed of multiple coupling blocks which are serially connected, said lamp arm structure being characterized in that each coupling block has an annular flange at the middle to divide the coupling block into two ends, one end of the coupling block being formed with a socket section, while the other end being formed with an engaging section which can be inserted into the socket section, whereby the coupling blocks can be serially connected to form the chain structure, each coupling block being freely universally rotatable about the engaging section so that the lamp arm can be multidirectionally bent to adjust the angle of a bulb holder.

2. The lamp arm structure as claimed in claim 1, wherein the engaging section has several domed protuberances on the surface for preventing the engaging section from freely detaching from the socket section.
